(19) United States
(12) Patent Application Publication
(10) Pub. No.: US 2010/0023484 A1
(43) Pub. Date: Jan. 28, 2010

(54) SYSTEM AND METHOD FOR GENERATING PERSONALIZED EMERGENCY PLANS

(76) Inventors: Russell Todd Zink, Westlake Village, CA (US); Justin D. Zink, Sausalito, CA (US)

Correspondence Address: TSIRCOU INTELLECTUAL PROPERTY LAW, 655 Central Ave., 17th Floor, Glendale, CA, 91203, US

(21) Appl. No.: 12/179,200

(22) Filed: Jul. 24, 2008

(51) Int. Cl. G06F 7/06; G06F 17/30

(52) U.S. Cl. 707/3; 707/104.1; 707/E17.014; 707/E17.044

(57) ABSTRACT

A system and method is provided, that manages, and tracks substantial, detailed information related to prescribed users, to include information gathering from users as well as gathering information from third parties or other publically available sources. With this information, the system provides users detailed and relevant emergency plans without overwhelming them with irrelevant information. Moreover, the system can provide plans tailored to the types of emergencies, whether natural or manmade, the user might encounter.

### FIELD OF THE INVENTION

The present invention relates generally to systems and methods in the field of emergency planning and, more particularly, to the field of generating emergency plans and kits personalized to a user's particular circumstances.

### BACKGROUND OF THE INVENTION

Regardless of location or circumstance, we all are endangered by natural disasters, terrorist actions, and other threats. The aftermath of recent disasters including floods, wild fires, hurricanes and terrorist attacks, all illustrate the substantial damage to property and needless mortality that can be wrought. Recent disasters also illustrate the important role proper planning can play in minimizing property loss, physical suffering, and loss of life.

In the event of a large-scale crisis, it can be a considerable time before government and other emergency organizations can come to the aid of individuals, particular when confined in their residences. This is due in large part because national, state, and local governments have limited resources. In the hours immediately following such an event, such organizations often need to focus attention on public areas and on combating additional threats As such, it is very important for individuals to have the capacity to survive without substantial assistance. Self-sufficiency goes a long way in minimizing property loss, injury, or mortality.

Unfortunately, history teaches that many individuals and families are ill prepared and poorly equipped for disaster or crisis situations. They lack proper planning and supplies to survive in such emergencies. This problem is exacerbated, because it can be a time consuming and expensive endeavor to properly plan and equip oneself for emergencies. Moreover, it appears that some are willing to assume the risk, hoping that they will never need evacuation plans and kits.

However, disasters such as earthquakes, tornados, wildfires, and floods, as well as threats such as, terrorist attacks and shootings, are inevitable and unpredictable. Idleness, lack of information, or belief in good fortune cannot be factors when dealing with such disasters.

It should, therefore, be appreciated that there remains a need for system and related method that enables individuals and families to prepare and equip themselves in the event of an emergency. The present invention fulfills these needs and others.

### SUMMARY OF THE INVENTION

Briefly, and in general terms, the invention provides a system and method that manages and tracks substantial, detailed information related to prescribed users, to include information gathered from users as well as gathering information from third parties or other publically available sources. With this information, the system provides users detailed and relevant emergency plans without overwhelming them with irrelevant information. Moreover, the system can provide plans tailored to the types of emergencies, whether natural or manmade, the user might encounter.

More particularly, and in an exemplary embodiment, the system includes a database management system (DMS) having data stored on a computer-readable medium. The DMS can include a plurality of residence datasets, each residence dataset having prescribed data elements including residence location, residence type, and building safety features; a plurality of household-member datasets, each household-member dataset having prescribed data elements including number of household occupants, age, contact information, and medical information; and a plurality of local-area datasets, each local-area dataset having prescribed data elements regarding the local area of the residence, including location and contact information for emergency services. The system further includes a plan generator in communication with the DMS.

The plan generator can include computer-readable instructions on a computer-readable medium, the instructions include selecting an emergency plan template based upon datasets assigned to a user, assigning items and steps to the emergency plan template based upon datasets assigned to a user, and delivering the emergency plan to the user, the plan having a listing of items, steps, and emergency contact information determined based upon the datasets assigned to a user. The plan covers actions for the user before, during, and after a disaster. For example, the plan can provide instructions for the safeguarding of important documents, as well as, the retrieval or reconstitution of such documents after a disaster.

In a detailed aspect of an exemplary embodiment, the system can aid in preparing an emergency kit for users. To that end, the system queries the user to identify those items that the user already owns. Based on provided and other relevant information, the system proposes additional items needed. The other relevant information can include details about the residence, types of threats or natural disasters for the local area, and details about the family members, to name a few. Recommended items for the emergency kit are presented to the user for consideration. The system includes the ability to purchase the items individually. If the user chooses, they can purchase every recommended item in a customized emergency kit that will be assembled and shipped to the user.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein. Moreover, a number of features are discussed throughout the specification with reference to particular embodiments. Nonetheless, those skilled in the art will appreciate that various other embodiments can be provided without departing from the scope of the invention, to include any and all combination of features discussed.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a simplified block diagram of a system for generating personalized emergency plans in accordance with the present invention.

FIG. 2 is a simplified block diagram of a database structure and management system for use with the system of FIG. 1.

FIG. 3 is a simplified block diagram for steps of the system of FIG. 1.

FIG. 4 is an exemplary input page for receiving property information for step 1 of the steps provided in FIG. 3.

FIG. 5 is an exemplary input page for receiving household resident's information for step 2 of the steps provided in FIG. 3.

FIG. 6 is an exemplary page for depicting local emergency information accessed for step 3 of the steps provided in FIG. 3, including a mapping ability.

FIG. 7 is an exemplary emergency plan resulting from the steps of FIG. 3.

FIG. 8 is an exemplary emergency kit provided in accordance with the system of FIG. 1.

### DETAILED DESCRIPTION OF PREFERRED EMBODIMENTS

Referring to the drawings, there is shown an exemplary embodiment of a system, identified by numeral 10, for generating personalized emergency plans in accordance with the invention. The system manages and tracks substantial, detailed information related to users' circumstances, to include information gathering from users as well as gathering information from third parties or other publically available sources. With this information, the system provides users detailed and relevant emergency plans without overwhelming them with irrelevant information. Moreover, the system can provide plans tailored to the types of emergencies, whether natural or manmade, the user might encounter.

The system 10 is configured to gather information concerning user's residence, household occupants, and local area, among other things. The system uses this information to assess the household's level of preparedness in event of emergencies and prepare appropriate plans. The system assesses and improves the household's level of readiness on a broad level, such as, evacuation, water and food reserves, emergency communications, shelter and so on. The system also assesses and improves the household's level of readiness for specific types of disasters that are prevalent in their local area, such as earthquake, wild fires, floods, drought, tornadoes, snowstorms, hurricanes, and so on. To that end, information gathered can drive entries into the resultant emergency plan. The system can further prepare an emergency plan tailored to all the relevant types of disasters to the user's circumstances and area.

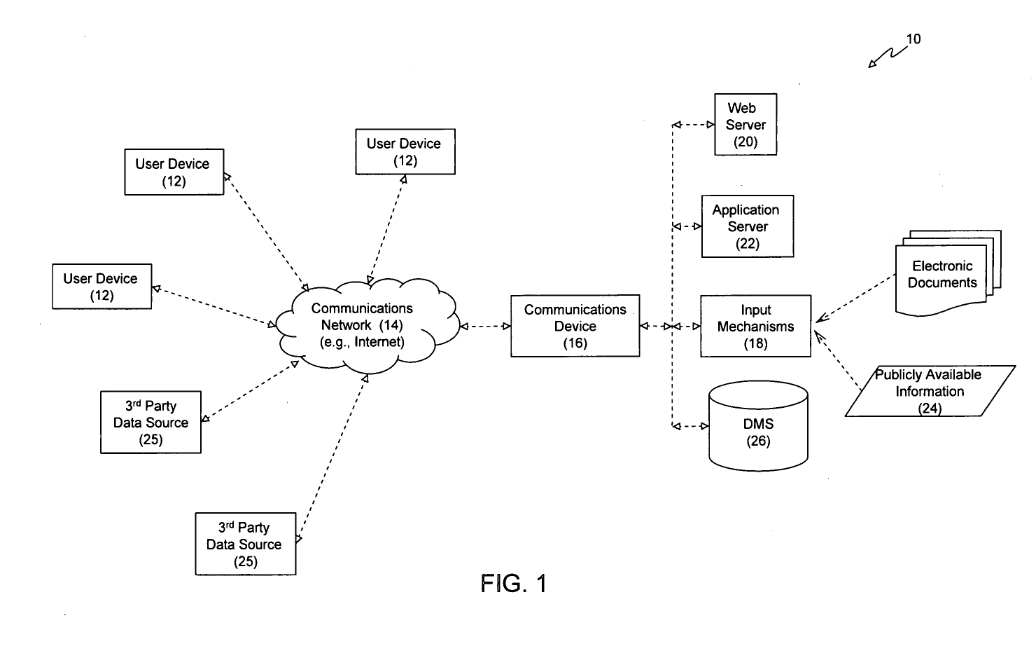

With reference now to FIG. 1, there is shown a simplified block diagram of the system 10, having a plurality of components in communication with one another and with user devices 12, via a communications network 14 and through at least one communications device 16. User devices can include among other things, personal computers, cell phones, and personal digital assistants. Connections between components are shown using double-sided arrows, which may be physical, fiber optic, wireless, or any other type of communications link. Additionally, other types of communication means and/or protocols can be used, for example, a customer can transfer information by means of a memory card and memory card reader.

The system 10 includes input mechanisms 18 that can be used to provide data, electronic documents, and other information to the system. Input mechanisms include, for example, scanners, recorders, phones, facsimile machines, keyboards, touch screens, mice, and any other type of device usable for providing input storable in digital format into the system.

A web server 20 stores and runs applications for a website of the system 10 and is connected to the communications network 14 through the communications device 16. Multiple servers may be included to accommodate high-volume demand on the system. The application server 22 stores the applications for the website. The application server also runs applications that direct the data and information in among the various components, modules, and servers of the system.

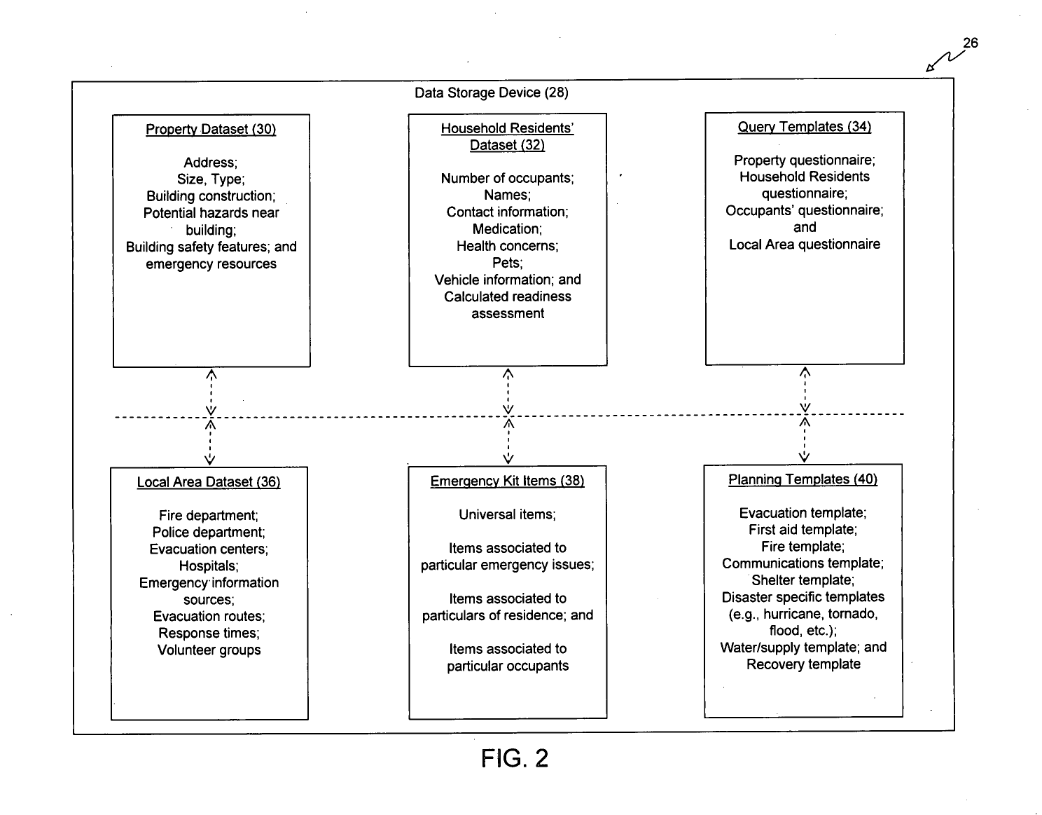

With reference now to FIG. 2, the system 10 includes a data management system (DMS) 26 that includes a data storage device 28 having data dispersed among several datasets, including property datasets 30, household residents' datasets 32, query templates 34, local area datasets 36, emergency kit items datasets 38, and planning templates 39. Additional information regarding these datasets will be discussed throughout this description. It will be appreciated that data can be organized into various different database configurations without departing from the present invention. In the exemplary embodiment, the datasets are stored in an individual database; however, in other embodiments, various other database configurations can be used, singly or in combination, such as, relational, distributed, hierarchical, object-oriented, object-relational, temporal, and XML data stores, and so on. Data can be stored on single or multiple data storage devices.

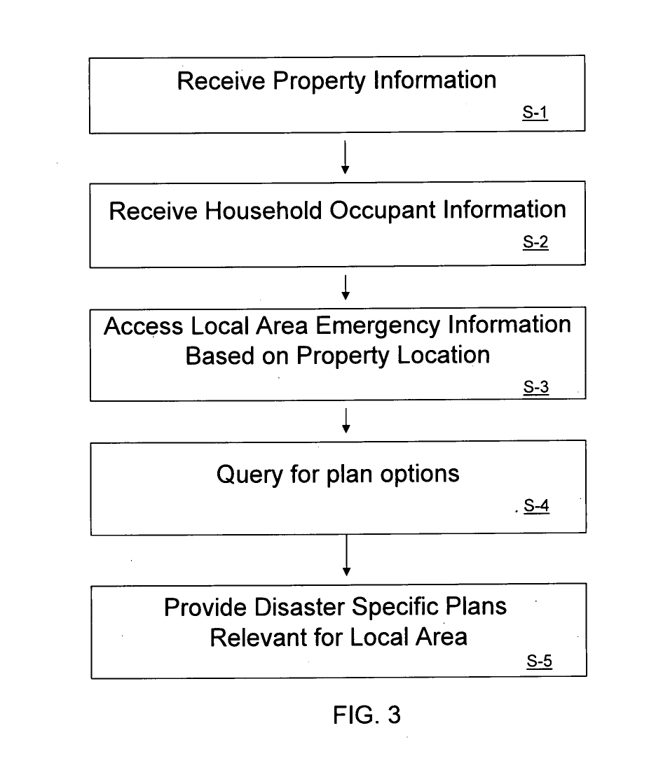

With reference now to FIG. 3, exemplary steps of the system 10 for generating a personalized emergency plan are provided. At steps 1 and 2 (S-1, S-2), the system gathers information for the user's property and household residents. This information is stored in a property dataset and a household residents' dataset, respectively, associated with the user. In the exemplary embodiment, the system has access to local area information for the user's location (S-3). In the exemplary embodiment, the system can identify potential threats (natural or manmade) based at least in part on the residence location.

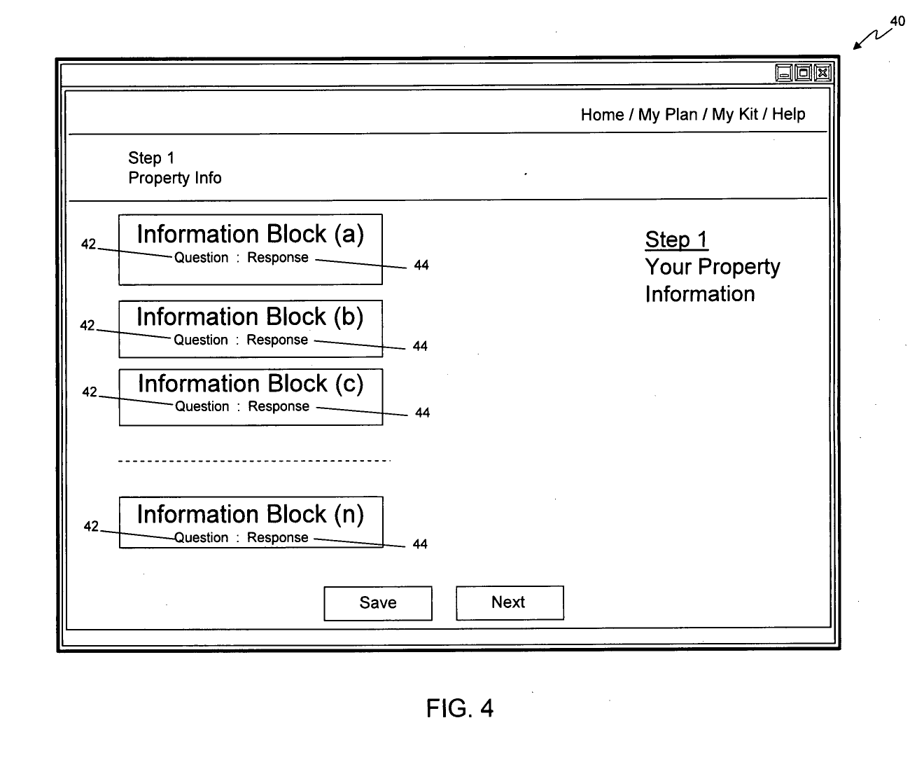

Referring to FIG. 4, the system 10 gathers information about the user's property through a web page 40 that poses selected questions 42 to users. The system 10 stores responses 44 in a residence dataset 32 associated with the user and utilizes the information to aid in preparing emergency plans for the user.

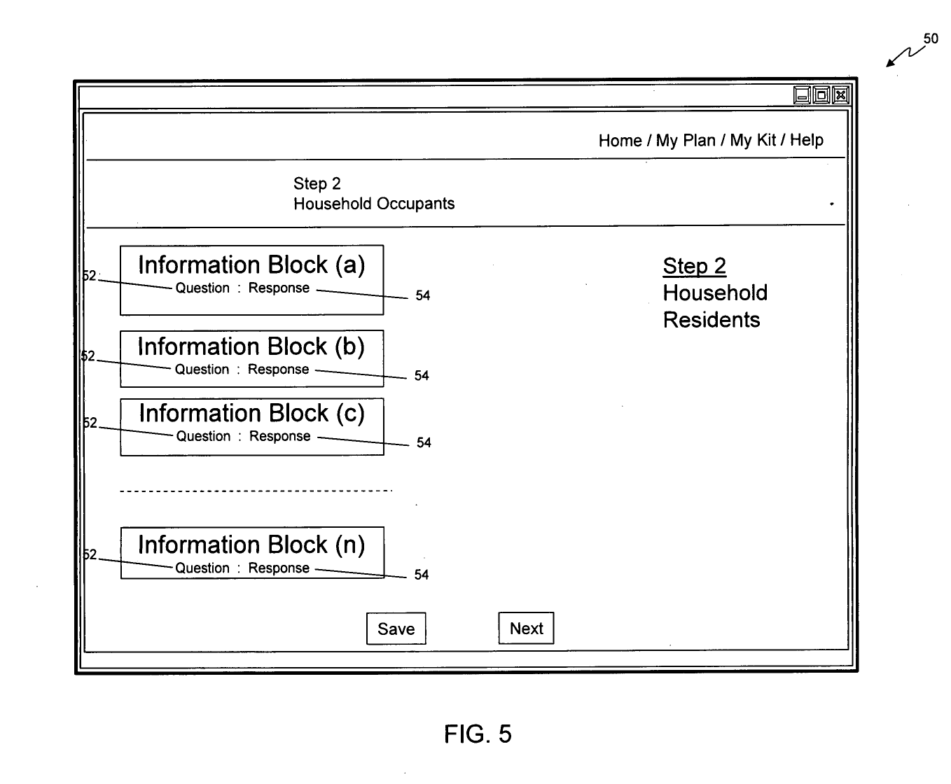

The questions presented and the associated areas for response from the user are depicted in FIG. 5 as “Information Blocks” (a-n) for convenient reference. In the exemplary embodiment, the web page 40 is configured to pose a plurality of questions that are tailored to the user's situation. More particularly, the system is configured to tailor the questions presented according to responses provided by the user to prior questions. For example, Information Block (a) could pose a question to the user as to the category of dwelling, e.g., single-family home or multi-unit building. If the user owns a single-family home, the system will present subsequent question(s) (e.g., Information Blocks (b, c)) to gather relevant information relevant for single-family homes; whereas, if the user lives in a multi-unit building, the system will present subsequent question(s) (e.g., Information Blocks (b, c)) appropriate for multi-unit buildings, as discussed below. For example, the residence information can include details about the construction and safety features of the residence. The system can use this detailed information in developing tailored plans. For example, the construction details, such as roof material used (e.g., composite, wood shake), can be used by the system in developing a fire preparedness plans. In addition, details about the building's foundation, e.g., whether bolted or otherwise retrofitted, or whether shelves or other furniture is secured to the building can be used in developing a plan for earthquake preparedness.

### Example #1

### Conditional Questions Regarding Backup Power Supply

1. Is your home equipped with a backup power supply like a generator?
   a) Yes
   b) No
1b. If yes to A1, Do you have enough fuel and power to last 7 days? This is a conditional question and is only seen if the user answers Yes to A1.
   a) Yes
   b) No

In Example #1 above, the system first presents Question 1 regarding whether or not your home is equipped with a back up power supply. If the user's response to Question 1 is “Yes,” the system will present a secondary question. If, for example, the user response with a “No” to Question 1 then the system will not present the secondary question and move on to a next topic of inquiry.

Information concerning the layout of the property can also be used in developing various plans for users. For example, the number of stories, windows, and exits, can all be used in developing evacuation plans. In addition, this information can also be used in developing plans for securing the residence in event of weather events, such as hurricanes, high winds, and tornados. For example, the system can recommend appropriate materials and methods for protecting windows from damage. In this manner, the system provides users with detailed and appropriate information tailored to their circumstances, without overwhelming them with irrelevant information.

The system 10 continues in this manner with a series of questions to gather sufficient information (e.g., through Information Block (n)). The web page 40 is configured to modify its presentation of questions in this manner.

In the exemplary embodiment, the system is configured to pose a plurality of questions to gather property information to include—(a) property address; (b) type of property (e.g., single-family or multi-unit); (c) for single-family properties, details of the size of the residence such as square footage, lot size, garage size, number of rooms on each floor, basement details, and crawl space information; (d) for multi-unit properties, number of floors for building, number of units in complex, and location of unit; (e) construction of property information, type of roof material (e.g., wood, composite, or tile), type of construction of structure (e.g., wood, brick, or steel), construction of first-floor doors, construction of first-floor windows, types of shutters, retrofit information, foundation information, and garage type; (f) potential hazards near the residence, such as number of large trees, nearest open space or wooded area, nearest type of body of water, proximity of power lines, and type the ground property rests on (e.g., clay, granite, or soil); (g) details regarding potential emergency resources in the residence, such as, type and location of water heater; type and location of gas shut-off valve; type and location of property water shut-off valve; (h) number and locations of fireplaces; (i) number and locations of ceiling fans; (j) location of electrical panel; (k) alternate power sources; (l) type and location of fire extinguishers; and (m) type and location of smoke alarms. The system can be configured to gather additional information as desired.

In other embodiments, at least some of the property information can be gathered by other means, e.g., from publicly available or commercially available sources such as government, insurance, or other real estate records.

With reference now to FIG. 5, web page 50 poses questions to gather information about the household residents to tailor the user's plan. The questions presented and the associated areas for response from the user are depicted in FIG. 5 as “Information Blocks” (a n). The system 10 stores responses to the presented questions in a household residents' dataset 32 associated with the user. The questions presented request household information, e.g., including number of individuals at the residence, age, contact information (e.g., various phone numbers and email addresses), medication needed (if any), and other health concerns or special needs. The system also queries for employment information including location of business and phone number, which can be used by the system to account for contacting individuals in case of emergency.

The questions of web page 50 also requests information concerning the number and types of vehicles owned by household occupants. Emergency items already in possession are also queried by the system. These steps allow for a more accurate and complete evacuation plan. The system also collected information concerning pets at the residence so that any pets can be accounted for in the plans.

In the exemplary embodiment, the web page 50 is configured to pose a plurality of questions that are tailored to the user's situation. More particularly, the system is configured to tailor the questions presented according to responses provided by the user to prior questions. The following example questions are provided as illustrative:

### Example #2

### Conditional Questions Regarding Pets in the Home

Pet 1. How many pets do you have in your home?
a) None
b) 1
c) 2
d) 3

Pet 1a. What is your pet's name?

Pet 1b. Do you have a portable cage for your this pet?
a) Yes
b) No

Pet 1c. What size is your pet?
a) Small
b) Medium
c) Large
d) Even Bigger

Pet 1d. What type of animal is your pet?
a) Dog
b) Cat
c) Other

In Example #2 above, the system first presents Question (Pet 1) regarding the number of pets in the home. If the user's response to this question is one or more, the system will present a set of questions (Pet 1a-Pet 1d) for each pet until the number of pets is satisfied. If, for example, the user had two pets, then the system would present questions (Pet 1a-Pet 1d) twice, once for each pet. If the user had no pets, the system would not present questions (Pet 1a-Pet 1d) at all; rather, the system would continue to a next topic of inquiry.

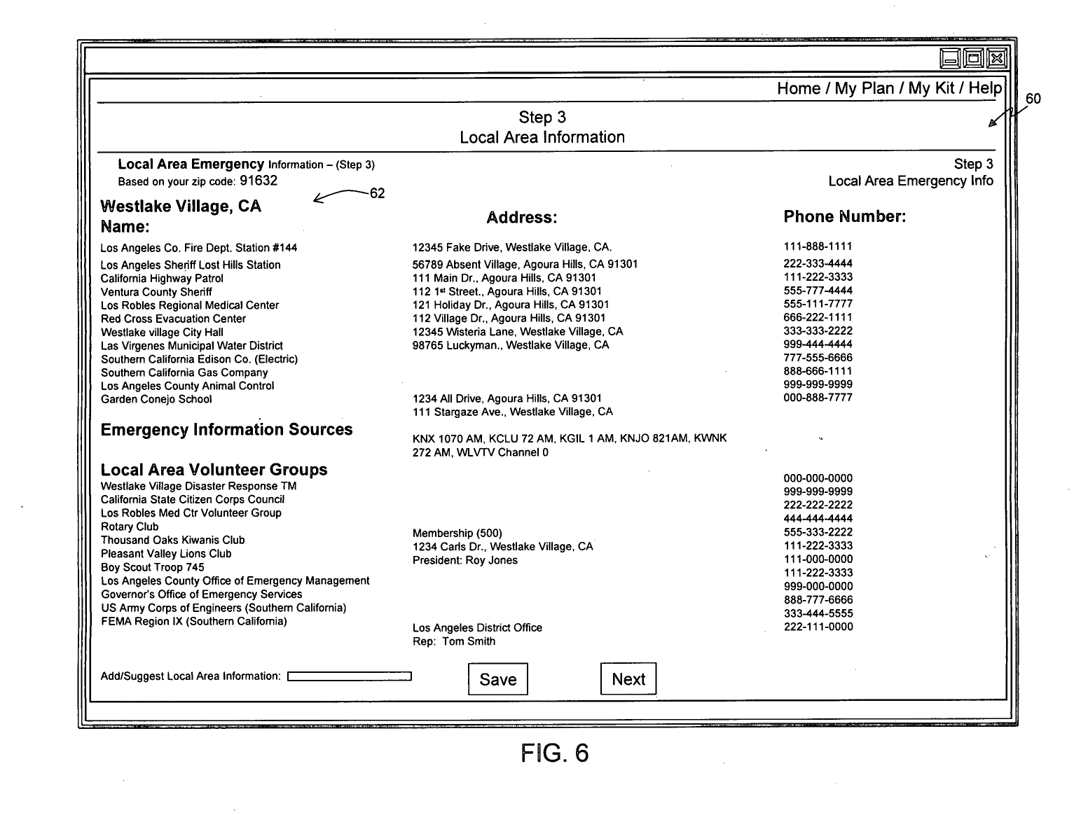

With reference now to FIG. 6, a webpage 60 is shown including local-area dataset 36 from the DMS 26. The web page 60 presents information detailing an exemplary local area, including location and contact information for fire departments, police departments, emergency evacuation centers, evacuation routes, and hospitals, to name a few. In addition, the DMS includes information concerning volunteer groups according to geographic location and services offered. Emergency information sources such as emergency broadcast services by radio or television are also managed.

The system can gather relevant information for publicly available sources such as publicly available information 24 inputted into the DMS or through third party data sources 25 available through the Internet, among other things (FIG. 1). The information is used by the system 10 to populate prescribed planning templates with information tailored for the user's needs. In addition, users can also add additional information for the local area such as local volunteer groups (e.g., CERT, Rotary Club, Boy Scouts, and so on) that could assist in the event of a local area disaster. Furthermore, the local area category can be enhanced by offering a template website to local municipalities and/or first responders such as fire or police to build a website that can quickly make available key information to their local public members. The local municipalities can be provided a password of their own to post important bulletins to their public members residing in their zip codes.

The system 10 is also configured to allow authorized personnel of the various organizations or groups to manage the group's information through secure accounts with the system. The system will periodically query the relevant personnel, such as through email requests, or through requests posted on the personnel's home page on the system, to review and update the group's information, as needed. This is beneficial to the organization in that it provides a convenient and effective means to present up-to-date information directly to the community.

Based on the information provided, the system 10 tailors plans to suit the user's needs. The system is configured to generate a variety of personalized plans, including plans for evacuation, first aid, communication, shelter, water, food, wildfires, floods, hurricanes, and earthquakes, to name a few.

In the exemplary embodiment, the system includes a plurality of plan templates used to generate plans tailored for users. The plan templates include computer-readable instructions for selecting details for inclusion into the resulting plan. The instructions include various logic codes, such as if-then statements, variable queries, iterative loop statements, and so on, for retrieving information from the datasets of the user and, when appropriate, inserting that information into the resulting plan.

For example, a plan template for an evacuation plan could include instructions to query a residence dataset associated with the user for information as to the type of residence of the user. Based on the retrieved information, particular evacuation instruction would be included in the plan. If the retrieved information indicated that the residence was a two-story single family residence, instructions could be included to provide and utility evacuation ladders positioned near second-story windows.

Below is a simplified example of a portion of a plan template having logic code to gather evacuation meeting locations for inclusion into an evacuation plan. The plan template includes scripted instructions that are included in all plans and includes computer-readable coded instructions that are executed to gather information from the DMS for inclusion in the resulting plan.

### Example #3

### Earthquake Readiness Plan (Output)

Brownouts and blackouts cut your home's crucial electrical supply. Backup power systems keep the furnace warm, the refrigerator cool, and your home's security system online.

{if $A_{—}1==‘Yes’ }
We recommend you ensure your generator is in working condition. (This may be a checklist item)

{if $A_{—}2==‘No’ }
We recommend you store enough fuel to supply your generator for more than 7 days.

{/if}

{else}
If possible, you should purchase or acquire a generator that has at least a 7 day capacity.

{/if}

In Example #3 above, a portion of a plan template directed to backup power supplies is shown. The plan template is configured to process user's responses to question posed in Example #1 above. If user responded “Yes” to question 1 of Example #1, then the plant template follows this logic ({if $A_{—}1==‘Yes’ }) and presents this response to the user (We recommend you ensure your generator is in working condition. (This may be a checklist item)). Thereafter, If the user's answered “No” to the subordinate question (question 1b of Example #1) which follows, then the system follows this logic ({if $A_{—}2==‘No’ }) and presents this response to the user (We recommend you store enough fuel to supply your generator for more than 7 days). Likewise, if the system receives anything else but a “Yes” to the initial question then it follows this logic ({/if} {else}) and presents this response (If possible, you should purchase or acquire a generator that has at least a 7 day capacity).

### Example #4

### Water Heater Details (Output)

{if $Z_{—}1==‘Yes’ }
Your water heater is securely fastened.

{elseif==I don't know}
Check to see that your water heater is securely fastened.

{/if}

{if $Z_{—}1==‘No’ OR $Z_{—}1==I don't know}
{if $Z_{—}1==‘I don't know’} If not securely fastened, we{else}We{/if} recommend you secure your water heater with a proper sized wire band.
[Clip from relevant article which describes how to fasten your hot water heater]
{if not print}
[Link to article]
{/if}

{/if}
We recommend you have your water heater inspected by an earthquake specialist in your area. Find specialists in your area (link to directory)

{if $B_{—}1>0}

Example #4 depicts an portion of a exemplary plan template directed to instructions for a home's water heater, based upon responses provided by user's to the questions presented in Example #2 above. If a user responds to “Yes” to the question of whether or not the water heater is secure, the system provides this response (Your water heater is securely fastened). If the user's response to whether or not the water heater is secure is “I don't know” the system will present this response (Check to see that your water heater is securely fastened). If the user responds to the question with a “No” or “I don't know” the system will present this response ({if $Z_{—}1==‘No’ OR $Z_{—}1==I don't know} {if $Z_{—}1==‘I don't know’}If not securely fastened, we{else}We{/if} recommend you secure your water heater with a proper sized wire band.) which is a recommendation that the system provides. The system also provides links to articles which will help the user comply with the recommendations.

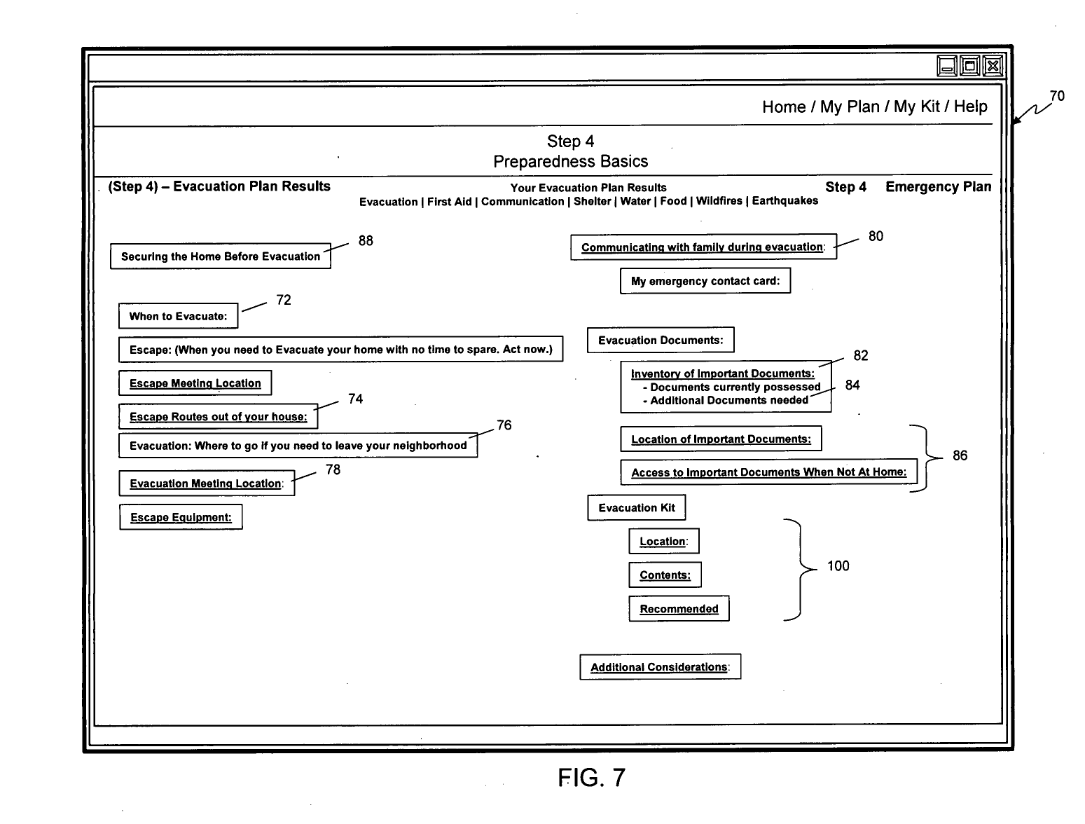

With reference now to FIG. 7, an exemplary evacuation plan 70 is shown. The plan provides sources for real-time emergency broadcasts 72, escape routes out of the residence 74 and out of the area 76, meeting locations for family members 78, communication methods for family members 80, and so on.

Information received from a dataset of the user can be depicted in the plan by a first mode of emphasis, e.g., a single underline. The instructions further include such logic codes to assess the nature and types of instructions that are tailored to the user's circumstances. In the exemplary embodiment, such instructions that are included in the plan are depicted by a second mode of emphasis, e.g., double underline. Modes of emphasis can include font type, font size, italics, underlining, coloring, highlighting, images, icons, and other various means known for emphasizing information such as text or images. Action items can be provided to users to improve their preparedness. The system can be configured for periodic reminders on an ongoing basis to manage the user's preparedness.

An evacuation plan 70 can also include information provided by the user. Particular sections and instructions are inserted, or excluded, in to specific plans based on information gathered for the user at prior steps. For example, a user residing on an upper floor of a multi-unit residence would be provided evacuation instructions particular to that scenario. Those instructions would in certain respects from instructions provided to a user residing in a single level, single-family residence. The system is able to combine the various responses by collecting all the data in a database and then sorting it out according to its programmed combination methods.

Users can view or email to friends and family their entire emergency preparedness plan as an entire document or by category or subcategory. The plan has categories and subcategories tabbed for quick access. If a member clicks on one of these it takes them to that portion of the plan with the text of the plan incorporating the user's personalized responses to the questions. Listed will be customized output clauses, relevant equipment items shown to the right, and relevant reference websites listed below for those users that wish to review more information on the specific category.

The system analyzes the user's information and, based on that assessment, provides recommendations in the plan. The recommendations are depicted in a manner to attract the attention of the user. For example, in the exemplary embodiment, the plan lists critical documents 82 that have been set aside in the event of evacuation. Based on this response, the system provides a list of additional documents 84 that should be set aside. The system also provides recommendations for document retention 86 and for securing the home before evacuation 88. For example, the plan can provide instructions for the safeguarding of important documents, as well as, the retrieval or reconstitution of such documents after a disaster.

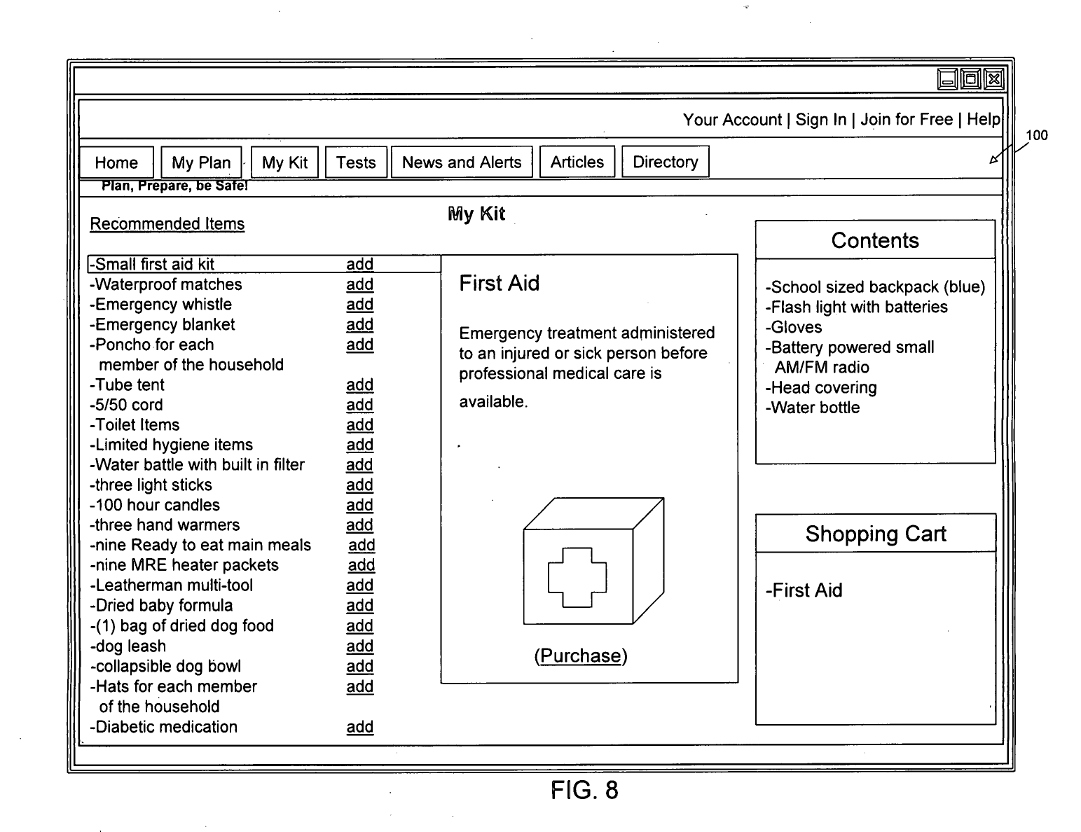

With reference now to FIG. 8, the system 10 is further configured to aid in preparing an emergency kit 100. To that end, the system queries the user to identify those items that the user already owns. Then, based on that information and other relevant information, the system proposes additional items needed. The other relevant information can include details about the residence, types of threats or natural disasters for the local area, and details about the family members, to name a few.

In the exemplary embodiment, recommended items for the emergency kit are presented to the user for consideration, to include photos of the item. The system includes the ability to purchase the items individually. If the user chooses, they can purchase every recommended item in a customized emergency kit that will be assembled and shipped to the user.

To further demonstrate the benefits of the system the following example is provided. This example should be construed only as illustrative, and it does not limit the disclosure or the claims.

### Example #5

### Exemplary Plan Result

The user, Mr. Smith, lives in Westlake Village, Calif. at 123 Village Drive, and has provided all information requested by the system through the system's webpages (e.g., FIGS. 4 and 5). Based on the provided information the system generated an emergency plan. In the example, underlined items reference information gathered from the user, and italicized and underlined items reference information added to the plan by the system that directs Mr. Smith to take specific action for further preparedness. The plan is as follows:

Evacuation Plan:

This emergency evacuation plan is designed for the Smith Family located at 123 Village Drive. Do not rely on local or state emergency management and law enforcement agencies for your safe evacuation. You must prepare. Evacuation can happen anytime and anywhere. A natural disaster such as an approaching hurricane or wildfire, an accident such as a toxic chemical spill, or an intentional event such as an act of terrorism are examples of emergencies that could make evacuation necessary. The answers below have been personalized and customized for you and your family based on the answers you have provided.

When to Evacuate:

Listen to your local emergency radio stations: KNX 1070 AM, KCLU 720 AM, KGIL 600 AM, and KNJO 821 AM. Watch you local emergency television station: WLVTV Channel 0. You can also check in with neighbors (My Emergency Contact Card), follow disasters online, or check in with friends and family where an approaching disaster is currently taking place.

Escape:

When you need to evacuate your home with no time to spare. Act Now.

Meeting Location:

The meeting location in the event of a rapid escape (fire, earthquake, etc.) from the home is right outside the home at the fire hydrant across the street. This allows the household to get immediate accountability of all household members in the event of a fire, earthquake, or some other kind of immediate disaster.

Escape Routes Out of Your House:

Property Details—Type: 3 bedroom 2 bath, 2 story home Rooms: Primary and Secondary Escape Routes 2nd Floor: Master Bedroom—primary: door, secondary: balcony; 1st Floor: Children's bedroom. Prior to exiting any doors be sure to look under door and feel door for heat. If you must exit to assist children, try yelling first. If no response, soak and wrap a sheet around your body, ventilate your breathing, and stay low upon exiting the door. If you cannot exit the door, escape using balcony and try another route such as your child's window over garage.

Escape Equipment (74):

If you are trapped on the second floor, you must know how to reach your loved ones and assist in getting them and yourself out of the house. Escape ladder is located in the master bedroom under the bed, next to the window. It is recommended that you mark the location of the escape ladder so the entire family knows where it is located. You should also take the ladder out of the box and test it to know exactly how you would secure the end of it and how long it goes down the side of the house. You also have bed sheets that can be tied in knots every three to four feet to act as an improvised rope. Fire extinguishers (1) next to stove unmarked (2) in upstairs linen closet unmarked, mark outside of locations with extinguisher placards. Smoke detectors (1) upstairs bedroom (2) dining room, last time serviced is unknown; check the safety indicator located on the detector itself Replace batteries. First aid kits. Do you have a first aid kit for household? No, purchase basic first aid kit and place it near evacuation kit. Cell Phone: Yes. Emergency phone numbers in phone: No. Store numbers in phone to alert fire stations and assistance. You will greatly increase your chance of survival in the need of an escape if you rehearse and practice the escape routes. Children are at greatest risk if they are untrained.

Evacuation: Where to go if You Need to Leave Your Neighborhood.

If evacuation seems eminent, read through this plan and take action. If you feel you may not be able to evacuate or you are told to stay in place, refer to your Shelter Plan.

Evacuation Meeting Location:

At the time of an emergency, your family may not be together. It is important to choose family meeting places. Remember that bridges may be out and roads may be blocked by debris, so choose your meeting places carefully with access in mind. Pick places that are easy to identify, that can be reached on foot if necessary, and that are in an accessible, open area. Take into account where each of you will likely be at different times and on different days. Establish plans with other family members for meeting up outside of the evacuation area. Make sure each member knows the location of the established meeting points. Meeting location #1: Aunt Mary's house and Meeting location #2: Mr. and Mrs. Johnson's house.

Evacuation Routes:

The emergency evacuation plan for your neighborhood can be handy in a large disaster. By plotting out potential routes on a city map before the disaster, you will save yourself from having to figure something out while in a hurry. You should avoid routes with obvious hazards, or routes, which are likely to be impassible in a disaster. (You probably will want to drive the routes before deciding.) In addition, avoid common routes that may be congested during an emergency. Your two evacuation routes are: Route 1: Take 5th street to the grocery store and turn left. Route 2: Take the 51 east and exit Glen Drive.

Communicating with Family during Evacuation:

You should have a phone list of three contacts, outside of your area. Each family member should carry a personal copy of the list. In an emergency, communications may be down in your area. Family members can contact the persons out of the emergency area to pass along messages and to check on the welfare of other family members. My emergency contact card: Be sure that each family member has a copy of the evacuation plan, maps, and telephone numbers.

Evacuation Documents:

Inventory of important documents—The important documents you currently have set aside in the event of evacuation include the following: copies of wills, passports and birth certificate. It is also recommended that you prepare these additional documents to be evacuated: Deeds of Trust, Death Certificates, Copies of Social Security Cards, Copies of Shot Records (adults, children, and pets) Copies of important Family documents such as family photos, Cash to get by for 72 hours to one week, Inventory of Items in the Home (furniture, jewelry, electronics), Key medical documents, Copies of Insurance Papers, and Emergency Contacts.

Location of Important Documents:

Your documents are currently located in a small plastic file cabinet in your home office. It is recommended that you purchase a water resistant and fireproof document safe that is portable to secure your most important documents for evacuation.

Access to Important Documents When Not At Home:

Your important documents are only located in your home. You do not have a secondary location outside of your home to secure your documents. It is recommended that you put the originals in a safety deposit box at you local bank for safekeeping. You may also wish to consider having all of your documents scanned into an outside secure database to make available to you online, at any time, anywhere in the world. Beyond the obvious reasons to keep these most important documents secure, the lengthy time it would take to replace them and for identification purposes during emergencies, they can become imperative in expediting your recovery through your insurance company and the government after a disaster.

Evacuation Kit:

Location: (1) Garage on the shelf. Contents: (1) School sized backpack (blue) (2) Flashlight with batteries (3) Gloves (4) Battery powered small AM/FM radio (5) Head covering (6) Water bottle. Recommended items for your emergency evacuation kit: (1) Small first aid kit, (2) Waterproof matches, (3) Emergency whistle, (4) Emergency blanket, (5) Poncho for each member of the household, (6) Tube tent, (7) 5/50 cord, (8) Toilet Items, (9) Limited hygiene items, (10) Water bottle with built in filter, (11) three light sticks, (12) 100 hour candles, (13) three hand warmers, (14) nine Ready to eat main meals, (15) nine MRE heater packets, (16) Leatherman multi-tool, (17) Dried baby formula, (18) (1) bag of dried dog food, (19) dog leash, (20) collapsible dog bowl, (21) Hats for each member of the household, and (22) Diabetic medication. It has a luggage tag on it. It is recommended that you place a large emergency orange tag on the backpack clearly identifying it as the emergency backpack with key identifying information in the event the bag becomes separated from you (i.e. home address, cell phone, etc).

Additional Considerations:

(1) Special need—Member (John) diabetic. Needs are located in disaster kit. (2) Special need—Pet Fido (needs). Needs are located unknown. Pack three days of food and water and necessary constraints for pets.

Securing the Home Before Evacuation:

If you have time during an evacuation, you may want to take steps to secure your house. Give some thought to what things you need to do to secure your house. Write down your plans and keep the paper in a safe and accessible location. It is important to secure your home since you may not be able to return home in the event of a disaster for a long period of time opening up the possibility that your home could be looted in your absence. Your home is currently secured with a solid wood front entry door with a double lock. The first floor windows are made of wood single pane glass. If looting of your home is a major concern during your absence it is recommended that you review the following items to enhance the security of your home: (1) Outside shutters that can secure first floor windows (2) Metallic roller shutters on first story windows (3) Professional security services (i.e. Brinks, ADT) (4) Securing the fence line and gates with locks (5) Installing metal entry doors on the first floor (6) Installing hurricane glass windows (7) Additional items to secure windows and doors to prevent entry. Additional steps include: Shutting off your gas line, located in laundry room next to kitchen; Shutting off your water line to the house, located in the laundry room to the left of the door; Shut-off for water heater located hallway closet.

It should be appreciated from the foregoing that the present invention provides a system and method that manages and tracks substantial, detailed information related to prescribed users, to include information gathering from users as well as gathering information from third parties or other publically available sources. With this information, the system provides users detailed and relevant emergency plans without overwhelming them with irrelevant information. Moreover, the system can provide plans tailored to the types of emergencies, whether natural or manmade, the user might encounter.

Although the invention has been disclosed in detail with reference only to the exemplary embodiments, those skilled in the art will appreciate that various other embodiments can be provided without departing from the scope of the invention, to include any and all combination of features discussed. Accordingly, the invention is defined only by the claims set forth below.

What is claimed is:

1. In a computerized system for generating personalized emergency plans, a method comprising:
receiving user information via electronic transmission for storage in a database management system (DMS) having data stored on a computer-readable medium, the user information including designators denoting details of the size and structural components of the user's residence, details of the occupants of the residence, and the location of the residence;
querying a database for information on potential threats and emergency contact information for the location of the residence received with the user information;
executing computer readable instructions for assigning items and steps to an emergency plan based upon the user information; and
delivering the emergency plan having a listing of items, steps, and emergency contact information determined based upon the user information provided.

2. A method as defined in claim 1, wherein the user information stored in the DMS further includes residence location, residence type, and building safety features.

3. A method as defined in claim 1, wherein the user information stored in the DMS further includes number of household occupants, age, contact information, and medical information.

4. A method as defined in claim 1, wherein the information stored in the DMS further includes location and contact information for emergency services in the local area of a user.

5. A method as defined in claim 1, wherein the system delivers a residence evacuation plan based upon information from the residence dataset of the user, including residence type, residence size, and structural components of the user's residence.

6. A method as defined in claim 1, wherein the emergency plan includes steps selected based upon natural disaster threats for the location of the residence.

7. A method as defined in claim 1, wherein the emergency plan depicts information from datasets of the user displayed with a first mode of emphasis.

8. A method as defined in claim 7, wherein the emergency plan depicts instructions tailored for the user displayed with a second mode of emphasis.

9. A computer-implemented system for generating personalized emergency plans, comprising:
a database management system (DMS) having data stored on a computer-readable medium, the DMS including
a plurality of residence datasets, each residence dataset having prescribed data elements including residence location, residence type, and building safety features,
a plurality of household-member datasets, each household-member dataset having prescribed data elements including number of household occupants, age, contact information, and medical information,
a plurality of local-area datasets, each local-area dataset having prescribed data elements regarding the local area of the residence, including location and contact information for emergency services, and
a plan template having computer-readable instructions on a computer-readable medium, the instructions include assigning items and steps to the emergency plan template based upon datasets assigned to a user, the resulting emergency plan having a listing of items, steps, and emergency contact information determined based upon the datasets assigned to a user.

10. A system as defined in claim 9, wherein the resulting emergency plan includes steps selected based upon natural disaster threats for the location of the residence.

11. A system as defined in claim 9, wherein the system includes a plurality of plan templates, each plan template configured for a prescribed emergency situation.

12. A system as defined in claim 11, further comprising computer-readable selecting instructions on a computer-readable medium for selecting a plan template from the plurality of plan templates based upon information from the residence dataset of the user.

13. A system as defined in claim 12, wherein the selecting instructions further include selecting a plan template based upon information from the residence dataset of the user.

14. A system as defined in claim 9, wherein the emergency plan depicts information from datasets of the user displayed with a first mode of emphasis.

15. A system as defined in claim 14, wherein the emergency plan depicts instructions tailored for the user displayed with a second mode of emphasis.

16. In a computerized system for generating personalized emergency plans, a method comprising:
receiving user information via electronic transmission, the user information including designators denoting details of the size and structural components of the user's residence, details of the occupants of the residence, and the location of the residence;
querying a database for information on potential threats and emergency contact information for the location of the residence received with the user information;
selecting a plan template from a plurality of plan templates based upon information from the user;
executing computer readable instructions for assigning items and steps to an emergency plan based upon the user information; and
delivering the emergency plan having a listing of items, steps, and emergency contact information determined based upon the user information provided.

17. A method as defined in claim 16, wherein the system delivers a residence evacuation plan based upon information for the residence of the user, including residence type, residence size, and structural components of the user's residence.

18. A method as defined in claim 16, wherein the emergency plan includes steps selected based upon natural disaster threats for the location of the residence.

19. A method as defined in claim 16, wherein the emergency plan depicts information from datasets of the user displayed with a first mode of emphasis.

20. A method as defined in claim 19, wherein the emergency plan depicts instructions tailored for the user displayed with a second mode of emphasis.
